(19) United States
(12) Patent Application Publication
(10) Pub. No.: US 2014/0096060 A1
(43) Pub. Date: Apr. 3, 2014

(54) METHOD FOR ADJUSTING MULTI FUNCTION DISPLAY SETTINGS

(71) Applicant: NAVICO HOLDING AS, Egersund (NO)

(72) Inventors: Stephen Thomas, Tulsa, OK (US); Paul Butterworth, Auckland (NZ)

(21) Appl. No.: 13/866,568

(22) Filed: Apr. 19, 2013

Related U.S. Application Data
(60) Provisional application No. 61/708,531, filed on Oct. 1, 2012.
(60) Provisional application No. 61/801,374, filed on Mar. 15, 2013.

(51) Int. Cl. G06F 3/0482; G06F 3/0485

(52) U.S. Cl. CPC G06F 3/0482; G06F 3/0485
USPC 715/771

(57) ABSTRACT

Described herein are implementations of various technologies for an apparatus and method for displaying marine electronics data. In one implementation, non-transitory computer-readable medium has stored thereon computer-executable instructions. When the computer-executable instructions are executed by a computer, the computer-executable instructions cause the computer to perform various actions. In one implementation, the computer-executable instructions can cause the computer to display in a first window a plurality of options for adjusting one or more settings of marine electronics data. The computer can display in a second window a plurality of parameters associated with at least one of the plurality of options. When the computer receives a selection of one of the plurality of options that is different from the at least one of the plurality of options, the computer replaces the plurality of parameters associated with the at least one of the plurality of options displayed in the second window with a plurality of parameters associated with the selection.

### CROSS-REFERENCE TO RELATED APPLICATIONS

This application claims the benefit of U.S. Provisional Patent Application Ser. No. 61/708,531, filed Oct. 1, 2012, titled SIMULTANEOUS DISPLAY OF SETTING CATEGORIES WITH SETTING OPTIONS/PARAMETERS, and the disclosure of which is incorporated herein by reference.

This application claims the benefit of U.S. Provisional Patent Application Ser. No. 61/801,374, filed Mar. 15, 2013, titled METHOD FOR ADJUSTING MULTI FUNCTION DISPLAY SETTINGS, and the disclosure of which is incorporated herein by reference.

### BACKGROUND

1. Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Accurate data, including, for example, navigation, mapping, and the location of stationary and moving objects, can be very useful for marine activities. The operator of a marine vessel monitors marine traffic. A device that is easy to operate and that provides data in an easy to follow format can provide advantages to the vessel operator. Such advantages may include requiring less time to request and review information, which in turn provides the vessel operator with more time to monitor the marine traffic.

### SUMMARY

Described herein are implementations of various technologies for an apparatus and method for displaying marine electronics data. In one implementation, non-transitory computer-readable medium has stored thereon computer-executable instructions. When the computer-executable instructions are executed by a computer, the computer-executable instructions cause the computer to perform various actions. In one implementation, the computer-executable instructions can cause the computer to display in a first window a plurality of options for adjusting one or more settings of marine electronics data. The computer can display in a second window a plurality of parameters associated with at least one of the plurality of options. When the computer receives a selection of one of the plurality of options that is different from the at least one of the plurality of options, the computer replaces the plurality of parameters associated with the at least one of the plurality of options displayed in the second window with a plurality of parameters associated with the selection.

In another implementation, an apparatus includes one or more processors, a screen, and a memory. The memory has stored thereon a plurality of executable instructions. When the one or more processors execute the plurality of executable instructions, the plurality of executable instructions cause the one or more processors to display in a first window a plurality of options for adjusting one or more settings of marine electronics data. The one or more processors can display in a second window a plurality of parameters associated with at least one of the plurality of options. When receiving a selection of one of the plurality of options that is different from the at least one of the plurality of options, the one or more processors replace the plurality of parameters associated with the at least one of the plurality of options displayed in the second window with a plurality of parameters associated with the selection.

In another implementation, there is described a method for displaying marine electronics data on a multi function display (“MFD”) unit. The method includes displaying in a first window a plurality of options for adjusting one or more settings of marine electronics data; and displaying in a second window a plurality of parameters associated with at least one of the plurality of options. Upon receiving a selection of one of the plurality of options that is different from the at least one of the plurality of options, the method would replace the plurality of parameters associated with the at least one of the plurality of options displayed in the second window with a plurality of parameters associated with the selection.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 is a block diagram of a multi-function display in accordance with implementations described herein.

FIG. 2 is a flow diagram for displaying marine electronics data in accordance with implementations described herein.

FIG. 3 illustrates a schematic diagram of the multi-function display displaying a graphical user interface for providing a selection of marine electronics data types for display in accordance with implementations described herein.

FIG. 4 illustrates a multi-function display displaying a first window and a second window in accordance with implementations described herein.

FIG. 5 illustrates a window after scrolling in accordance with implementations described herein.

FIG. 6 illustrates a user selection of another type of marine electronics data in accordance with implementations described herein.

FIG. 7 illustrates the multi-function display with a parameter change in accordance with implementations described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the implementations.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

“Alternatively” shall not be construed to only pertain to situations where the number of choices involved is exactly two, but rather refers to another possibility among many other possibilities.

Touch screen devices may be used in conjunction with computing devices designed to access marine electronics data, such as chart data, sonar data, radar data, and structure data. The user may choose to access and/or alter settings relating to the data and/or to the computing device. For example, the user may wish to change the language of the computing device or to identify the software version number of the computing device. Further, the user may wish to alter options, parameters, global settings, sounds, time, coordinate systems, or satellite configurations relating to chart data, sonar data, or radar data.

In one implementation, the user may select an icon or menu option to access settings for the computing device and/or the data. Once accessed, the settings may be simultaneously displayed in two or more windows, where at least one window includes icons/menu options for settings categories and at least one other window includes icons/menu options for parameters/options relating to the settings categories. In another implementation, each window may be scrollable in a horizontal or a vertical manner.

The window for settings categories may include icons/menu options for chart data, sonar data, radar data, navigation data, system, or any other type of marine electronics data. The user may select one of the icons/menu options to choose a setting category. In response to the selection, the options/parameters for the chosen setting category may be displayed simultaneously/automatically in the window for the options/parameters relating to the settings categories. For example, a user selecting an icon representing sonar data in the Settings Categories window would result in the simultaneous display of options/parameters relating to sonar data in another window. The options/parameters relating to sonar data may allow a user to edit features such as ping speed, noise rejection, or any other implementation relating to sonar data as known to those in the art.

### Multi-Function Display

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

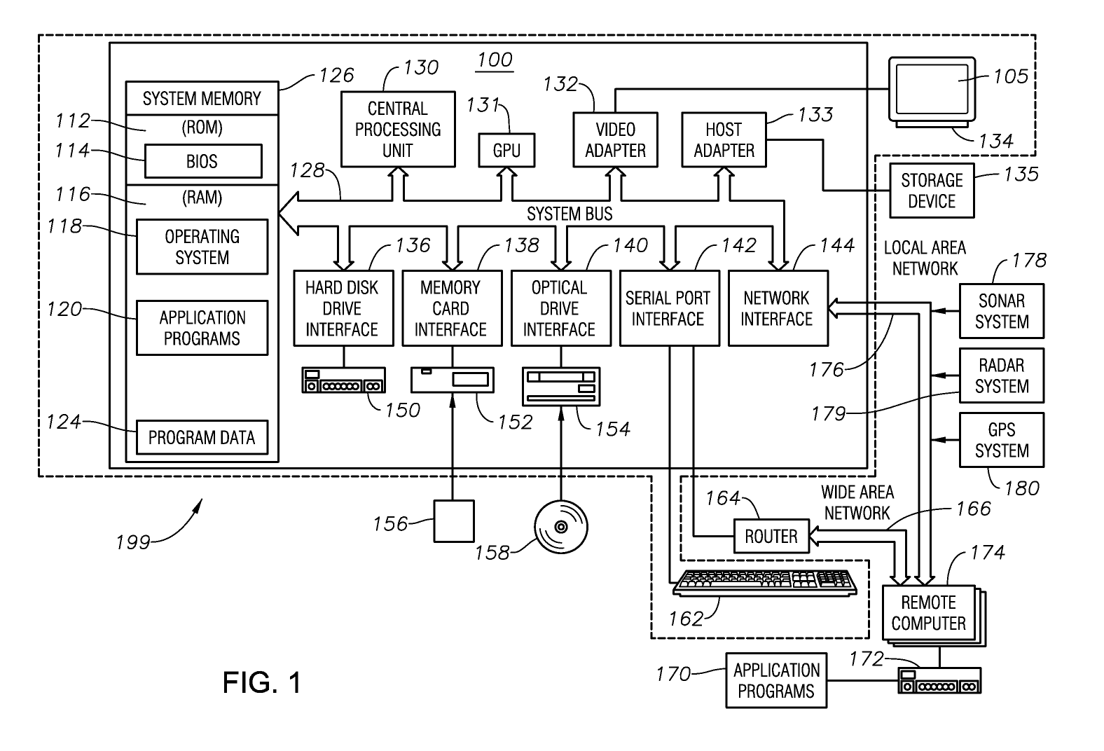

FIG. 1 illustrates a schematic diagram of a multi-function display 199 having a computing system 100 in which the various technologies described herein may be incorporated and practiced. The computing system 100 may be a conventional desktop, a handheld device, personal digital assistant, a server computer, electronic device/instrument, laptop, tablet, or part of a navigation system, marine electronics, or sonar system. It should be noted, however, that other computer system configurations may be used.

The computing system 100 may include a central processing unit (CPU) 130, a system memory 126, a graphics processing unit (GPU) 131 and a system bus 128 that couples various system components including the system memory 126 to the CPU 130. Although only one CPU 130 is illustrated in FIG. 1, it should be understood that in some implementations the computing system 100 may include more than one CPU 130.

The CPU 130 can include a microprocessor, a microcontroller, a processor, a programmable integrated circuit, or a combination thereof. The CPU 130 can comprise an off-the-shelf processor such as a Reduced Instruction Set Computer (RISC™), or a Microprocessor without Interlocked Pipeline Stages (MIPS™) processor, or a combination thereof. The CPU 130 may also include a proprietary processor.

The GPU 131 may be a microprocessor specifically designed to manipulate and implement computer graphics. The CPU 130 may offload work to the GPU 131. The GPU 131 may have its own graphics memory, and/or may have access to a portion of the system memory 126. As with the CPU 130, the GPU 131 may include one or more processing units, and each processing unit may include one or more cores.

The CPU 130 may provide output data to a GPU 131. The GPU 131 may generate graphical user interfaces that present the output data. The GPU 131 may also provide objects, such as menus, in the graphical user interface. A user may provide inputs by interacting with the objects. The GPU 131 may receive the inputs from interaction with the objects and provide the inputs to the CPU 130. A video adapter 132 may be provided to convert graphical data into signals for a monitor 134. The monitor 134 includes a touch screen 105. The touch screen 105 can be sensitive to heat or touching (now collectively referred to as a “touch screen”).

The system bus 128 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 126 may include a read only memory (ROM) 112 and a random access memory (RAM) 116. A basic input/output system (BIOS) 114, containing the basic routines that help transfer information between elements within the computing system 100, such as during start-up, may be stored in the ROM 112.

The computing system 100 may further include a hard disk drive interface 136 for reading from and writing to a hard disk 150, a memory card reader 152 for reading from and writing to a removable memory card 156, and an optical disk drive 154 for reading from and writing to a removable optical disk 158, such as a CD ROM or other optical media. The hard disk 150, the memory card reader 152, and the optical disk drive 154 may be connected to the system bus 128 by a hard disk drive interface 136, a memory card reader interface 138, and an optical drive interface 140, respectively. The drives and their associated computer-readable media may provide nonvolatile storage of computer-readable instructions, data structures, program modules and other data for the computing system 100.

Although the computing system 100 is described herein as having a hard disk, a removable memory card 156 and a removable optical disk 158, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 100 may also include a host adapter 133 that connects to a storage device 135 via a small computer system interface (SCSI) bus, a Fiber Channel bus, an eSATA bus, or using any other applicable computer bus interface. The computing system 100 can also be connected to a router 164 to establish a wide area network (WAN) 166 with one or more remote computers 174. The remote computers 174 can also include hard disks 172 that store application programs 170.

In certain implementations, various techniques, including the flow diagram, described herein can be implemented by a plurality of executable instructions stored in RAM. Alternatively, the plurality of executable instruction can be stored in the hard disk 150, or removable computer-readable media such as memory card 156 or optical media 158 until needed for execution.

A number of program modules may be stored on the hard disk 150, memory card 156, optical disk 158, ROM 112 or RAM 116, including an operating system 118, one or more application programs 120, and program data 124. The application programs 120 may include various mobile applications (“apps”) and other applications configured to perform various methods and techniques described herein. The operating system 118 may be any suitable operating system that may control the operation of a networked personal or server computer.

A user may enter commands and information into the computing system 100 through input devices such as buttons 162. Other input devices may include a microphone (not shown) or through the touch screen 105. These and other input devices may be connected to the CPU 130 through a serial port interface 142 coupled to system bus 128, but may be connected by other interfaces, such as a parallel port, game port or a universal serial bus (USB).

Certain implementations may be configured to be connected to a sonar system 178, radar interface 179, and GPS system 180. The sonar system 178, radar interface 179, and GPS system 180 may be connected via the network interface 144. The computing system 100, the monitor 134, the touch screen 105, and the buttons 162 may be integrated into a console, forming the multi-function display (“MFD”) 199.

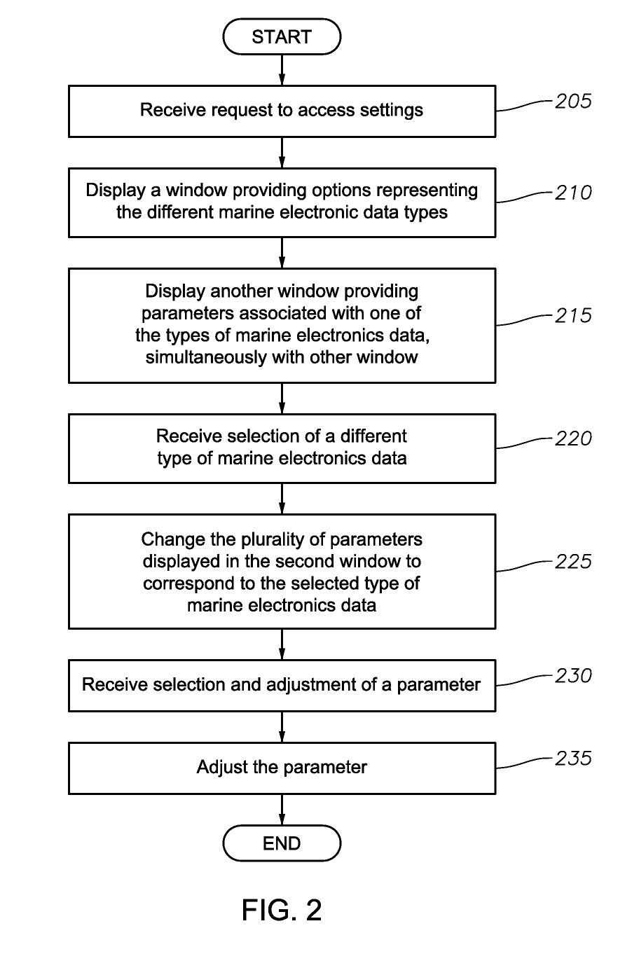

FIG. 2 illustrates a flow diagram for adjusting one or more settings of marine electronics data displayed on the MFD 199 in accordance with implementations described herein. It should be understood that while the operational flow diagram of FIG. 2 indicates a particular order of execution of the operations, in other implementations, the operations might be executed in a different order. Further, in some implementations, additional operations or steps may be added to the method. Likewise, some operations or steps may be omitted.

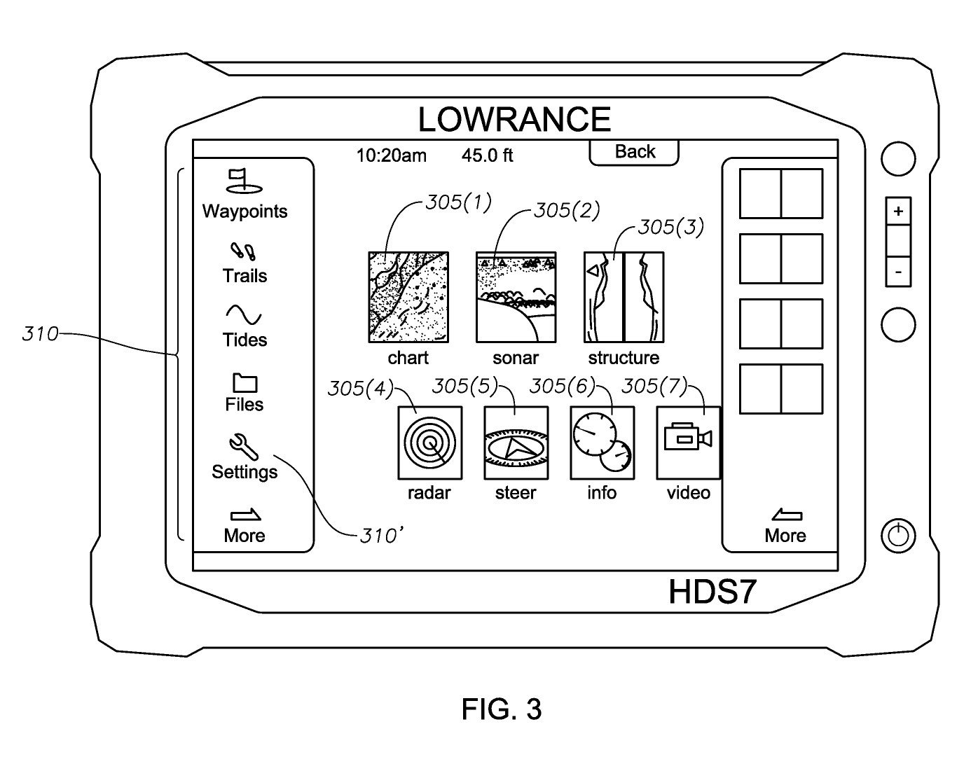

At block 205, the MFD 199 receives a request to access settings related to the types of marine electronics data. One implementation of receiving this request is illustrated in FIG. 3. FIG. 3 illustrates the MFD 199 with a graphical user interface for providing a selection of marine electronics data types for display in accordance with implementations described herein. The different marine electronics data types are represented by objects. In certain implementations, the objects can include icons 305. The icons 305 may include an icon for chart data type 305(1), sonar data type 305(2), structure data type 305(3), radar data type 305(4), steering data type 305(5), dashboard information type 305(6), and video 305(7). In other implementations, the objects can include other types of objects, such as menu selections (not shown).

The chart data type icon 305(1) may be configured for displaying a local map of a region surrounding the location of the display device 100. Where the display device 100 is carried over a body of water by a vessel, the sonar data type icon 305(2) may be configured for displaying sonar data from the body of water surrounding the vessel. The structure data type icon 305(3) may be configured for providing a higher resolution image covering a wider area of the body of water surrounding the vessel. The radar data type icon 305(4) may be configured for providing a radar view of the area surrounding the display device 100. The steering data type icon 305(5) may be configured for displaying information such as distance to destination, speed over ground, and time to destination. The dashboard data type icon 305(6) may be configured for displaying an instrument panel for a vessel carrying the display device. The instrument panel may include measurement meters that provide information such as, for example, bearing, speed, fuel level, and oil level. The video icon 305(7) may be configured for displaying video.

Additionally, the touch screen 105 displays a side tray of additional options 310. Among the additional options 310 is an icon 310′ for “Settings”. Selection of icon 310′ brings out a dual display of a number of marine electronics data types, and a display of parameters associated with one of the marine electronics data types. In one implementation, the MFD 199 may receive the selection by detecting a user touching icon 310′ with their finger.

Turning back to FIG. 2, at block 210 the MFD 199 displays a first window providing a plurality of options representing types of the marine electronics data on the screen 105. At block 215, the MFD 199 simultaneously displays a second window providing parameters associated with one of the types of the marine electronics data on the screen 105.

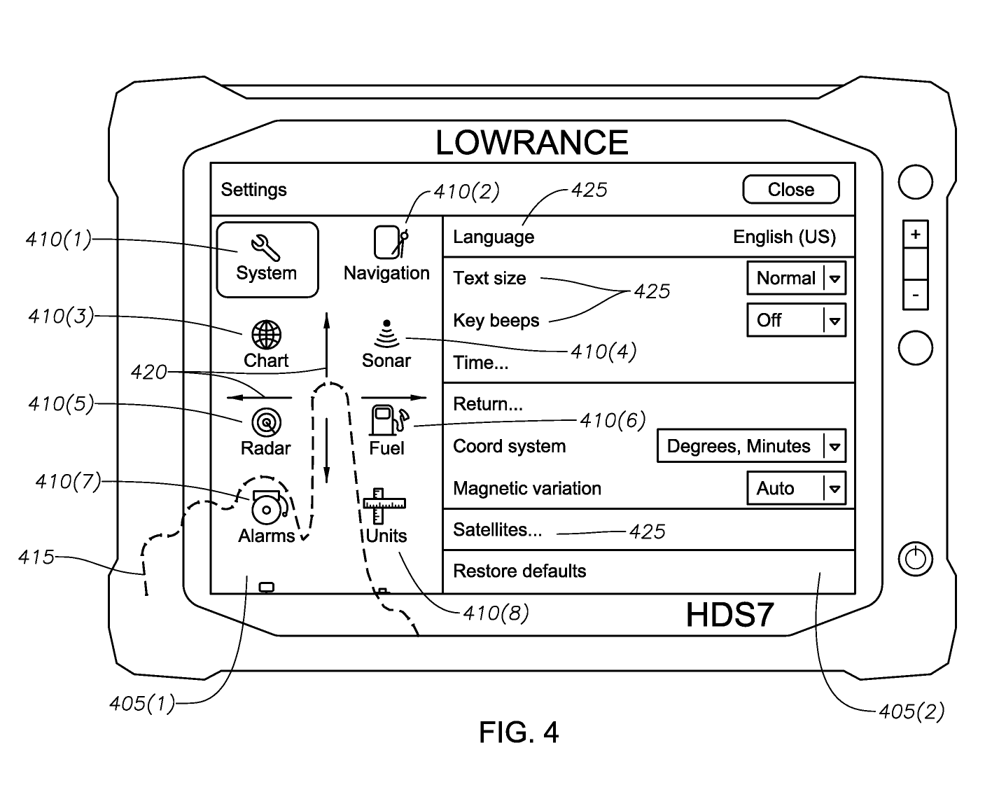

FIG. 4 illustrates a block diagram of the MFD 199 displaying a first window 405(1) and a second window 405(2). The first window 405(1) provides options representing different types of marine electronics data. As previously mentioned above, the options representing the different types of marine electronics data may include objects. In certain implementations, the objects can include icons 410.

The first window 405(1) can display icons for the system 410(1), navigation 410(2), chart data 410(3), sonar data 410(4), radar data 410(5), fuel levels 410(6), alarms 410(7), and units 410(8), among others. The first window 405(1) can be horizontally or vertically scrollable. Scrolling the first window 405(1) causes the first window to display other icons 410.

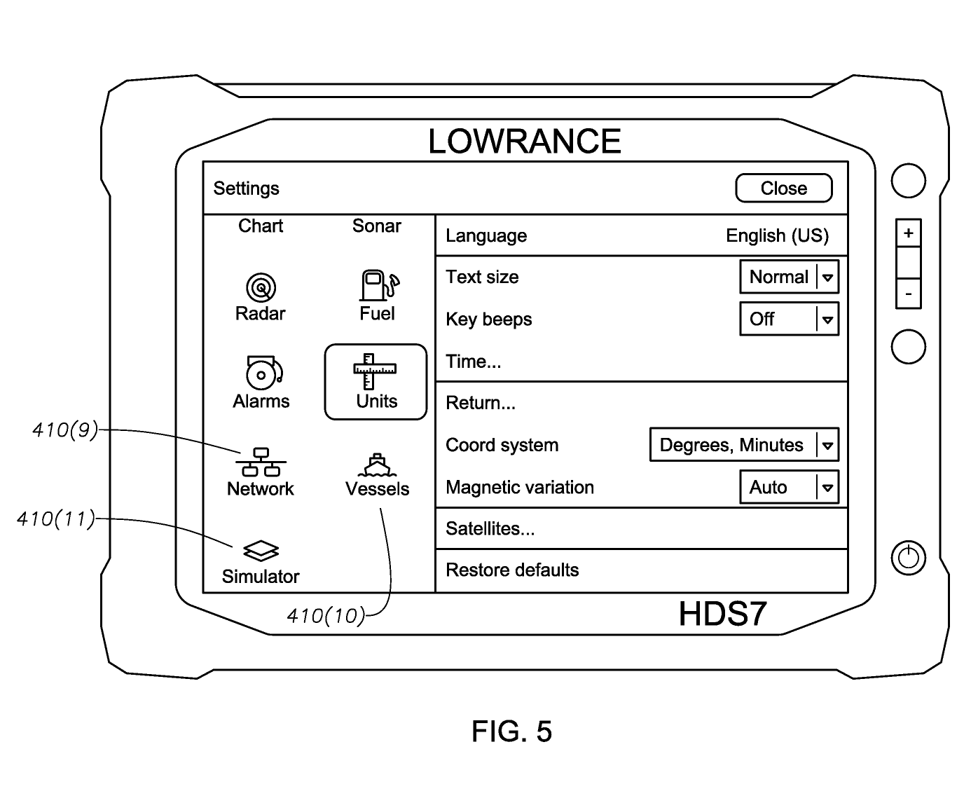

In certain implementations, the user can scroll the first window 405(1) by swiping the first window 405(1) with their finger 415. Swiping may include touching, dragging in a particular direction 420, and releasing a point in the window 405(1) with the finger 415. The window 405(1) will move in generally the opposite direction to the dragging direction 420. FIG. 5 illustrates the first window 405(1) after scrolling downwards (dragging upwards). As shown in FIG. 5, the first window 405(1) may display additional icons representing networking 410(9), vessels 410(10), and a simulator 410(11).

Returning to FIG. 4, the second window 405(2) can list a set of adjustable parameters 425 that are associated with one of the types of marine electronics data, which may be represented by the highlighted icon, e.g., 410(1), in the first window 405(1). The parameters 425 may be represented by objects. In certain implementations, the objects can include menu selections (shown) or icons (not shown). The second window 405(2) can also be scrollable in the horizontal and vertical directions. The second window 405(2) can also be scrolled by touching, dragging, and releasing as with the first window 405(1).

Returning to FIG. 2, at block 220, the MFD 199 receives a selection of an icon 410 representing a different type of marine electronics data. In response, at block 225, the MFD 199 changes the plurality of parameters displayed in the second window to the parameters associated with the selected type of marine electronics data during block 220.

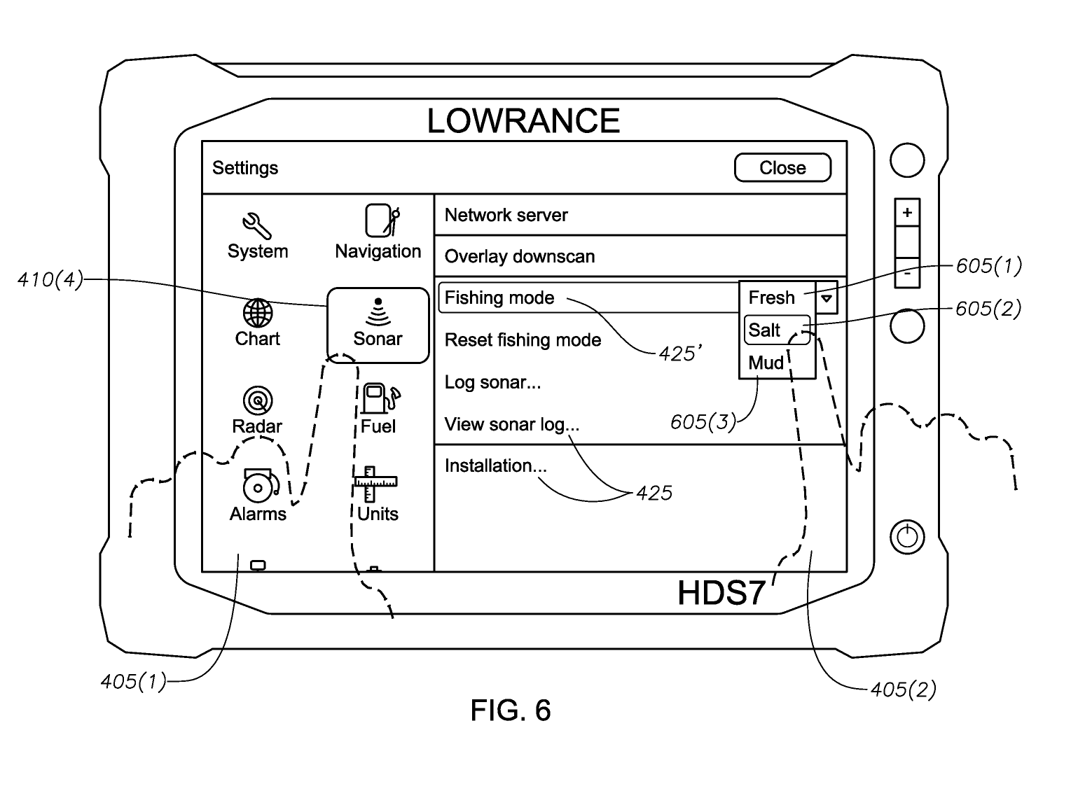

FIG. 6 illustrates a block diagram describing a user selection of another type of marine electronics data, as performed at block 220. In certain implementations, the user can select the different type of marine electronics data by simply touching the icon, e.g., 410(4), representing the desired type marine electronics data, e.g., sonar data.

As a result, the parameters 425 displayed in the second window 405(2) are changed to parameters 425 that are associated with the sonar marine electronics data. In certain implementations, the user can select and adjust a particular one of the parameters 425′ by selecting the menu option associated with the parameter. The user can select the parameter by simply touching the menu option associated with the parameter. The selection of the menu option associated with parameter 425′ may result in presentation of options for adjusting the parameter.

For example, selection of the menu selection associated with parameter, “fishing mode” 425′, may result in a drop down menu of different types of fishing waters, e.g., fresh water 605(1), salt water 605(2), and muddy water 605(3). The user can then adjust the “fishing mode” parameter 425′ by selecting a particular one of the different types of fishing waters, e.g., salt water 605(2), by touching the menu selection associated with the salt water.

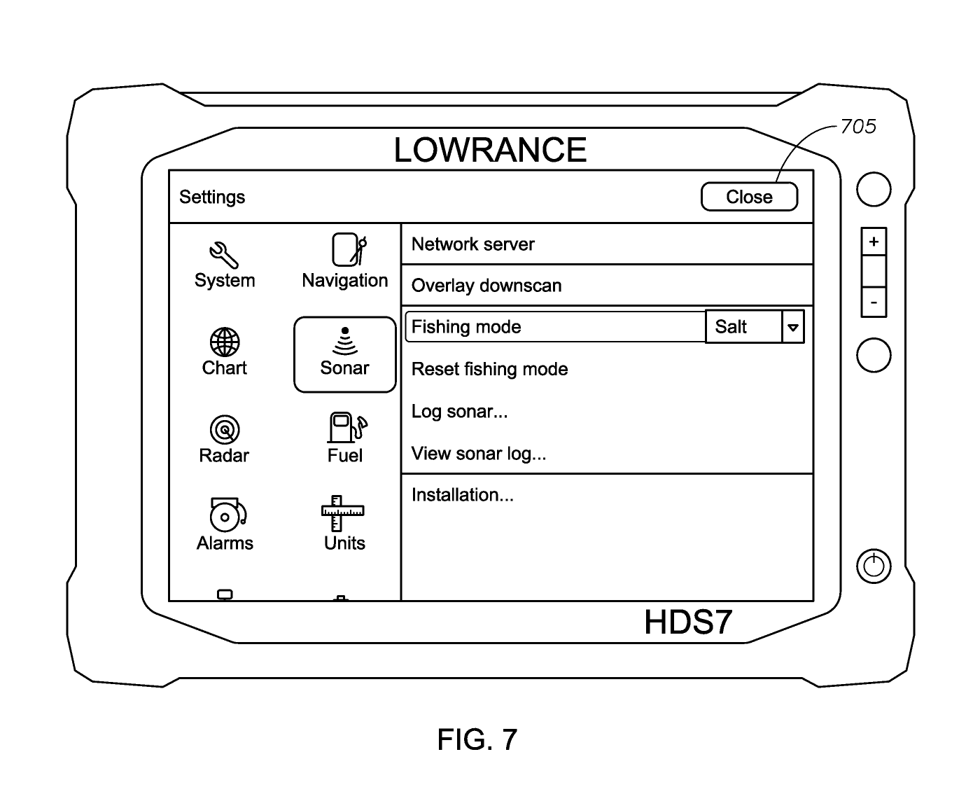

FIG. 7 illustrates the MFD 199 with the parameter for “fishing mode” set for the sonar data to “salt water” as changed in FIG. 6. The user can discontinue setting parameters for types of marine electronics data by selecting or touching the close button 705.

Although various implementations have been described with reference to various marine electronics data, it should be understood that in some implementations the technologies described herein may be applicable to modifying the settings of the MFD or the vessel on which the MFD is disposed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
display in a first window a plurality of options for adjusting one or more settings of marine electronics data;
display in a second window a plurality of parameters associated with at least one of the plurality of options;
receive a selection of one of the plurality of options that is different from the at least one of the plurality of options; and
replace the plurality of parameters associated with the at least one of the plurality of options displayed in the second window with a plurality of parameters associated with the selection.

2. The non-transitory computer-readable medium of claim 1, wherein the computer-executable instructions that cause the computer to replace the plurality of parameters comprise computer-executable instructions to automatically display the plurality of parameters associated with the selection responsive to receiving the selection.

3. The non-transitory computer-readable medium of claim 1, wherein the first window and the second window are displayed simultaneously.

4. The non-transitory computer-readable medium of claim 1, further comprising computer-executable instructions which, when executed by a computer, cause the computer to receive a request to access the options for adjusting the one or more settings, and wherein the first window and the second window are displayed responsive to receipt of the request.

5. The non-transitory computer-readable medium of claim 1, wherein at least one of the first window and the second window are scrollable.

6. The non-transitory computer-readable medium of claim 1, wherein the computer-executable instructions that cause the computer to receive the selection of the one of the plurality of options comprise computer-executable instructions that cause the computer to:
detect touching of an object representing the selection, wherein the object is selected from a group consisting of an icon and a menu selection.

7. The non-transitory computer-readable medium of claim 1, wherein the computer-executable instructions also cause the computer to:
receive a selection of one of the plurality of parameters associated with the selection; and
adjust the selected one of the plurality of parameters.

8. The non-transitory computer-readable medium of claim 1, wherein the computer-executable instructions also cause the computer to:
receive a selection of one of the plurality of parameters associated with the selection; and
display a plurality of options for the selected one of the plurality of parameters.

9. The non-transitory computer-readable medium of claim 8, wherein the plurality of options for the selected one of the plurality of parameters are displayed on a drop down menu.

10. An apparatus comprising:
one or more processors;
a screen; and
a memory having stored thereon a plurality of executable instructions which, when executed by the one or more processors, causes the one or more processors to:
display in a first window a plurality of options for adjusting one or more settings of marine electronics data;
display in a second window a plurality of parameters associated with at least one of the plurality of options;
receive a selection of one of the plurality of options that is different from the at least one of the plurality of options; and
replace the plurality of parameters associated with the at least one of the plurality of options displayed in the second window with a plurality of parameters associated with the selection.

11. The apparatus of claim 10, wherein the executable instructions that cause the computer to replace the plurality of parameters comprise executable instructions to automatically display the plurality of parameters associated with the selection responsive to receiving the selection.

12. The apparatus of claim 10, wherein at least one of the first window and the second window are scrollable.

13. The apparatus of claim 10, wherein the executable instructions that cause the computer to receive the selection of the one of the plurality of options comprise executable instructions that cause the computer to:
detect touching of an object representing the selection, wherein the object is selected from a group consisting of an icon and a menu selection.

14. The apparatus of claim 10, wherein the memory further comprises executable instructions that cause the computer to:
receive a selection of one of the plurality of parameters associated with the selection; and
display a plurality of options for the selected one of the plurality of parameters.

15. The apparatus of claim 14, wherein the plurality of options for the selected one of the plurality of parameters are displayed on a drop down menu.

16. A method for displaying marine electronics data on a multi function display (“MFD”) unit, comprising:
displaying in a first window a plurality of options for adjusting one or more settings of marine electronics data;
displaying in a second window a plurality of parameters associated with at least one of the plurality of options;
receiving a selection of one of the plurality of options that is different from the at least one of the plurality of options; and
replacing the plurality of parameters associated with the at least one of the plurality of options displayed in the second window with a plurality of parameters associated with the selection.

17. The method of claim 16, wherein replacing the plurality of parameters comprises automatically displaying the plurality of parameters associated with the selection responsive to receiving the selection.

18. The method of claim 16, wherein at least one of the first window and the second window are scrollable.

19. The method of claim 16, wherein receiving the selection of the one of the plurality of options comprises detecting touching of an object representing the selection, wherein the object is selected from a group consisting of an icon and a menu selection.

20. The method of claim 16, further comprising:
receiving a selection of one of the plurality of parameters associated with the selection; and
displaying a plurality of options for the selected one of the plurality of parameters.
